(19) United States
(12) Patent Application Publication
(10) Pub. No.: US 2018/0012162 A1
(43) Pub. Date: Jan. 11, 2018

(54) HUMAN RESOURCE DEVELOPMENT SUPPORT SYSTEM

(71) Applicant: Kabushiki Kaisha Kobe Seiko Sho (Kobe Steel, Ltd.), Kobe-shi (JP)

(72) Inventor: Youichirou SOU, Kobe-shi (JP)

(73) Assignee: Kabushiki Kaisha Kobe Seiko Sho (Kobe Steel, Ltd.), Kobe-shi (JP)

(21) Appl. No.: 15/636,798

(22) Filed: Jun. 29, 2017

(30) Foreign Application Priority Data
Jul. 5, 2016 (JP) 2016-133392

(51) Int. Cl. G06Q 10/06; G06Q 10/10; G06Q 30/02

(52) U.S. Cl. CPC G06Q 10/06311; G06Q 30/0204; G06Q 30/02; G06Q 10/06; G06Q 10/063112; G06Q 10/0631; G06Q 10/105

(57) ABSTRACT

A human resource development support system calculates, for each agent, a profitability indicator value that is a value of an indicator of profitability of the agent on the basis of order histories for customers regarding industrial machinery at the agent. Then, the human resource development support system generates, for each agent, reference information capable of identifying a grade of service personnel for which human resource development is to be strengthened, on the basis of the calculated profitability indicator value and on the basis of constitution information indicating the numbers of service personnel belonging to the agent for individual grades.

### BACKGROUND OF THE INVENTION

### 1. Field of the Invention

The present invention relates to a human resource development support system for supporting human resource development for service personnel involved in providing maintenance services for industrial machinery such as construction machinery.

### 2. Description of the Related Art

Japanese Unexamined Patent Application Publication No. 2005-10868 discloses a sales support system that is capable of selecting an appropriate customer to support sales activities for construction machinery. The sales support system includes a database that stores customer information, and customer information that matches customer search conditions input by an information recipient is extracted from the database. Thereafter, in response to input of at least two evaluation items regarding graphical display by the information recipient, the extracted customer information is analytically evaluated on the basis of the combination of the evaluation items. By referring to the results of the analytical evaluation, the information recipient can select an appropriate customer as a target for sales promotion.

The sales support system described above can provide efficient sales activities because it can easily select an appropriate customer as a target for sales promotion. However, if it is not possible to provide services of a level that is satisfactory for the selected customer, it is difficult to receive an order from the customer. Therefore, assistance that leads to enhancement in service providing performance is necessary. In particular, in the case of industrial machinery, after the customer has purchased a product, maintenance services for the product, such as maintenance inspection, repair, and provision of technical information, are generally offered, and a support that can provide high-quality maintenance services is desirable.

### SUMMARY OF THE INVENTION

Accordingly, it is a main object of the present invention to provide a human resource development support system that can provide a sufficient level of maintenance services to customers.

To this end, an aspect of the present invention provides a human resource development support system for supporting creating a plan for training and development of service personnel belonging to each of a plurality of agents of industrial machinery. The human resource development support system includes a profitability indicator value calculation unit that calculates, for each of the plurality of agents, a profitability indicator value that is a value of an indicator of profitability of the agent on the basis of order histories for customers regarding industrial machinery at the agent; a reference information generation unit that generates, for each of the plurality of agents, human-resource-development reference information capable of identifying a grade of service personnel for which human resource development is to be strengthened, on the basis of the profitability indicator value calculated by the profitability indicator value calculation unit and on the basis of constitution information indicating the numbers of service personnel belonging to the agent for individual grades; and an output unit that outputs the human-resource-development reference information generated by the reference information generation unit.

In this aspect, the reference information generation unit may be configured to generate human-resource-development reference information capable of identifying a grade of service personnel for which human resource development is to be strengthened in a first agent, on the basis of the constitution information on a second agent having a higher profitability indicator value than the first agent.

In the aspect described above, furthermore, the reference information generation unit may be configured to generate human-resource-development reference information capable of identifying a grade of service personnel for which human resource development is to be strengthened in a first agent, on the basis of the constitution information on a second agent having a service-providing-performance indicator value substantially equal to a service-providing-performance indicator value of the first agent and having a higher profitability indicator value than the first agent.

In the aspect described above, furthermore, the reference information generation unit may be configured to generate human-resource-development reference information capable of identifying a grade of service personnel for which human resource development is to be strengthened in a first agent, on the basis of the constitution information on a second agent having a number of service personnel substantially equal to the number of service personnel of the first agent and having a higher profitability indicator value than the first agent.

In the aspect described above, furthermore, the reference information generation unit may be configured to generate human-resource-development reference information capable of identifying a grade of service personnel for which human resource development is to be strengthened in a first agent, on the basis of the constitution information on a second agent having a larger number of service personnel than the first agent by a predetermined value and having a higher profitability indicator value than the first agent.

In the aspect described above, furthermore, the reference information generation unit may be configured to generate human-resource-development reference information capable of identifying a grade of service personnel for which human resource development is to be strengthened in a first agent, on the basis of the constitution information on a second agent having a number of managed pieces of industrial machinery substantially equal to the number of managed pieces of industrial machinery of the first agent and having a higher profitability indicator value than the first agent.

In the aspect described above, furthermore, the human resource development support system may further include a customer ratio calculation unit that calculates, for each of the plurality of agents, customer ratios for individual ranks, a customer ratio information generation unit that generates customer ratio information on customer ratios calculated for a second agent by the customer ratio calculation unit, the second agent being an agent having a higher profitability indicator value than a first agent, and a second output unit that outputs the customer ratio information generated by the customer ratio information generation unit.

In the aspect described above, furthermore, the human resource development support system may further include a storage unit that stores training material content corresponding to a grade of service personnel, an extraction unit that extracts, from the storage unit, training material content corresponding to a grade of service personnel for which human resource development is to be strengthened, the grade being identifiable using the human-resource-development reference information, and a providing unit that provides the training material content extracted by the extraction unit.

In the aspect described above, furthermore, the profitability indicator value calculation unit may include a rank setting unit that sets, for each of the plurality of agents, ranks of the customers on the basis of the order histories, and a good-customer-proportion calculation unit that calculates, for each of the plurality of agents, a proportion of good customers on the basis of the ranks of the customers set by the rank setting unit, and may be configured to calculate, for each of the plurality of agents, a profitability indicator value that is a value of an indicator of profitability of the agent on the basis of the proportion of good customers calculated by the good-customer-proportion calculation unit.

In the aspect described above, furthermore, the reference information generation unit may include a service-providing-performance indicator value calculation unit that calculates, for each of the plurality of agents, a service-providing-performance indicator value that is a value of an indicator of performance of the agent for providing services, on the basis of the numbers of service personnel belonging to the agent for the individual grades, and a grouping unit that divides the plurality of agents into a plurality of groups on the basis of the calculated profitability indicator value and the service-providing-performance indicator value calculated by the service-providing-performance indicator value calculation unit, and may be configured to generate, for each of the plurality of groups obtained by the grouping unit, human-resource-development reference information capable of identifying a grade of service personnel for which human resource development is to be strengthened in each of the plurality of agents.

In the aspect described above, furthermore, the profitability indicator value calculation unit and the service-providing-performance indicator value calculation unit may be each configured to execute multiple regression analysis by using sales projection for a customer as a target variable and by using the numbers of service personnel for the individual grades and the calculated proportion of good customers as explanatory variables to acquire coefficients of the explanatory variables, and may be configured to calculate a profitability indicator value and a service-providing-performance indicator value, respectively, on the basis of the acquired coefficients of the explanatory variables.

A human resource development support system according to an aspect of the present invention may enable an improvement in service providing performance for providing services to customers.

### BRIEF DESCRIPTION OF THE DRAWINGS

FIG. 1 is a schematic diagram illustrating the configuration of a human resource development support system (server) according to an embodiment of the present invention and entities with which the server establishes a communication connection;

FIG. 2 is a block diagram illustrating the configuration of the human resource development support system (server) according to the embodiment of the present invention;

FIG. 3 is a conceptual diagram illustrating the configuration of a customer information management database;

FIG. 4 is a conceptual diagram illustrating the configuration of a customer satisfaction survey result database;

FIG. 5 is a conceptual diagram illustrating the configuration of a delivered-machine database;

FIG. 6 is a conceptual diagram illustrating the configuration of an order history database;

FIG. 7 is a conceptual diagram illustrating the configuration of a ranking result database;

FIG. 8 is a conceptual diagram illustrating the configuration of a training material content database;

FIG. 9 is a conceptual diagram illustrating the configuration of an agent database;

FIG. 10 is a conceptual diagram illustrating the configuration of a service personnel database;

FIG. 11 is a flowchart illustrating a processing procedure of a rank setting process executed by the human resource development support system according to the embodiment of the present invention;

FIG. 12 is a flowchart illustrating a processing procedure of a key performance indicator (KPI) value calculation process executed by the human resource development support system according to the embodiment of the present invention;

FIG. 13 illustrates an image of an S-P scatter diagram in the embodiment of the present invention;

FIG. 14 is a flowchart illustrating a processing procedure of a first human resource development support process executed by the human resource development support system according to the embodiment of the present invention;

FIG. 15 illustrates an example of an agent selection screen;

FIG. 16 is a flowchart illustrating a processing procedure of a reference information generation process executed by the human resource development support system according to the embodiment of the present invention;

FIG. 17 illustrates an example of a reference information display screen;

FIG. 18 is a flowchart illustrating a processing procedure of a training material content presenting process executed by the human resource development support system according to the embodiment of the present invention; and

FIG. 19 is a flowchart illustrating a processing procedure of a second human resource development support process executed by the human resource development support system according to the embodiment of the present invention.

### DESCRIPTION OF THE PREFERRED EMBODIMENTS

A preferred embodiment of the present invention will be described with reference to the drawings. Embodiments given below provide examples of a method and an apparatus for embodying a technical concept of the present invention, and the technical concept of the present invention is not limited to what is described below. The technical concept of the present invention may be variously changed without departing from the technical scope defined by the appended claims.

A human resource development support system according to an embodiment of the present invention is designed to support creating a plan for training and development of service personnel involved in maintenance services for industrial machinery. Examples of the industrial machinery may include various pieces of machinery such as various types of construction machinery and pieces of machinery installed in productive facilities such as factories, including a reciprocating compressor, a screw compressor, a turbo-compressor, a vacuum deposition apparatus, a tire testing machine, a continuous mixer, and a rubber mixer. Industrial machinery is used over a long-term period, and maintenance services such as repair, inspection, replacement of parts, and technical guidance are required. Such maintenance services are provided by agents under contract with the manufacturer of industrial machinery. Service personnel belonging to each agent have a role to perform sales activities for customers to encourage the customers to receive appropriate maintenance services.

### Configuration of Human Resource Development Support System

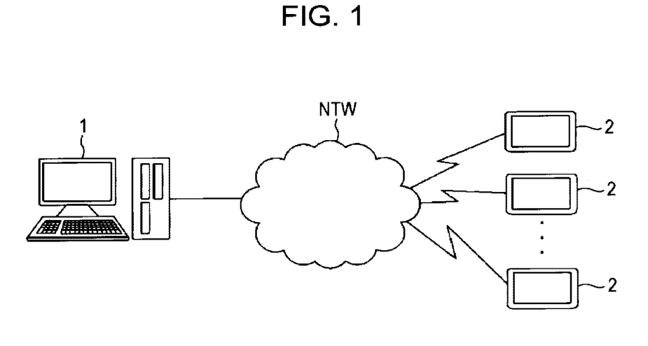

In this embodiment, the human resource development support system is implemented by a single server. FIG. 1 is a schematic diagram illustrating the configuration of the server and entities with which the server establishes a communication connection. A server 1 is connected to terminal devices 2 via a computer network NTW, such as the Internet, so as to be capable of communicating with the terminal devices 2. The terminal devices 2 are used in agents of the manufacturer of industrial machinery.

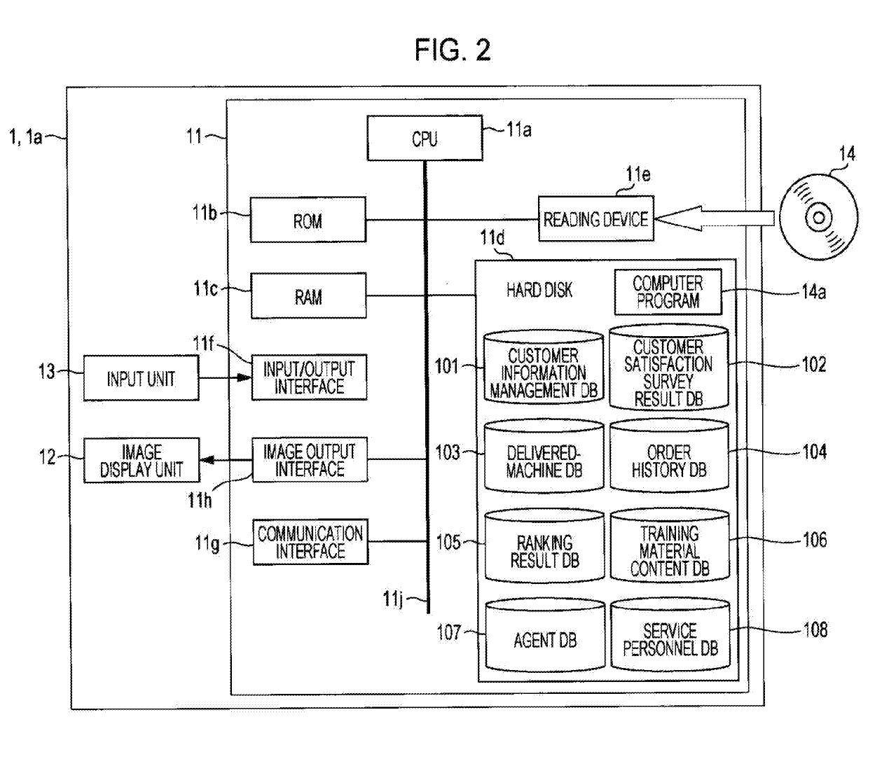

A detailed configuration of the server 1 will now be described. FIG. 2 is a block diagram illustrating the configuration of the server 1. The server 1 is implemented by a computer 1a. As illustrated in FIG. 2, the computer 1a includes a main body 11, an image display unit 12, and an input unit 13. The main body 11 includes a central processing unit (CPU) 11a, a read-only memory (ROM) 11b, a random access memory (RAM) 11c, a hard disk 11d, a reading device 11e, an input/output interface 11f, a communication interface 11g, and an image output interface 11h. These hardware components are connected via a bus 11j.

The CPU 11a is capable of executing a computer program loaded onto the RAM 11c. The CPU 11a executes a computer program 14a for supporting creating a plan for human resource development to allow the computer 1a to function as the server 1.

The ROM 11b is constituted by a mask ROM, a programmable ROM (PROM), an erasable PROM (EPROM), an electrically erasable PROM (EEPROM), or the like, and has recorded thereon a computer program to be executed by the CPU 11a, data used for the computer program, and so on.

The RAM 11c is constituted by a static RAM (SRAM), a dynamic RAM (DRAM), or the like. The RAM 11c is used to read a variety of computer programs recorded on the hard disk 11d. The RAM 11c is further used as a work area of the CPU 11a when the CPU 11a executes a computer program.

The hard disk 11d has installed therein a variety of computer programs to be executed by the CPU 11a, such as an operating system and an application program, and data to be used to execute the computer programs. The hard disk 11d also has installed therein the computer program 14a.

The reading device 11e is constituted by a flexible disk drive, a compact disc ROM (CD-ROM) drive, a digital versatile disc ROM (DVD-ROM) drive, or the like and is capable of reading a computer program or data recorded on a portable recording medium 14. The portable recording medium 14 stores the computer program 14a, which enables the computer 1a to function as the server 1. The computer 1a reads the computer program 14a from the portable recording medium 14 by using the reading device 11e, and installs the computer program 14a into the hard disk 11d.

The computer program 14a can be provided not only by the portable recording medium 14 but also from an external device, which is connected to the computer 1a via a telecommunication line (either wired or wireless) so as to be capable of communicating with the computer 1a, over the telecommunication line. For example, the computer program 14a can be stored in a hard disk of a server computer on the Internet, and the computer 1a can access the server computer to download the computer program 14a and to install the computer program 14a into the hard disk 11d.

The hard disk 11d further includes a customer information management database (DB) 101, a customer satisfaction survey result database (DB) 102, a delivered-machine database (DB) 103, an order history database (DB) 104, a ranking result database (DB) 105, a training material content database (DB) 106, an agent database (DB) 107, and a service personnel database (DB) 108. The details of the individual databases will be described below.

The input/output interface 11f is constituted by, for example, a serial interface such as a Universal Serial Bus (USB) interface, an Institute of Electrical and Electronics Engineers (IEEE) 1394 interface, or an RS-232C interface, a parallel interface such as a small computer system interface (SCSI), an Integrated Drive Electronics (IDE) interface, or an IEEE 1284 interface, and an analog interface that includes, for example, a digital-to-analog (D/A) converter and an analog-to-digital (A/D) converter, and so on. The input/output interface 11f is connected to the input unit 13, which is constituted by a keyboard and a mouse. A user can input data to the computer 1a by using the input unit 13.

The communication interface 11g is an interface to be connected to the network NTW. The computer 1a transmits and receives data to and from the terminal devices 2, which are connected to the network NTW, through the communication interface 11g by using a predetermined communication protocol.

The image output interface 11h is connected to the image display unit 12, which is constituted by a liquid crystal display (LCD) or a cathode-ray tube (CRT) display, and outputs a video signal corresponding to image data provided by the CPU 11a to the image display unit 12. The image display unit 12 displays an image (screen) in accordance with the input video signal.

Next, the details of the databases described above will be described with reference to the drawings.

### (a) Customer Information Management DB 101

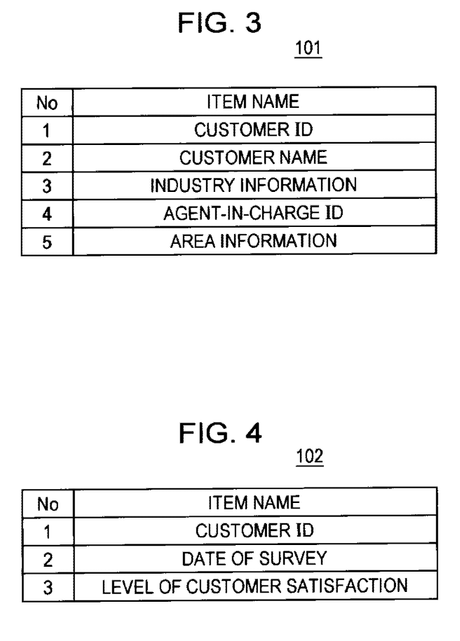

The customer information management DB 101 is a database for storing information concerning customers. FIG. 3 is a conceptual diagram illustrating the configuration of the customer information management DB 101. As illustrated in FIG. 3, the customer information management DB 101 includes a customer ID for identifying each customer, the name of the customer, industry information concerning the industry and market to which the customer belongs, an agent-in-charge ID for identifying an agent in charge of the customer, and area information indicating where the customer is located.

### (b) Customer Satisfaction Survey Result DB 102

The customer satisfaction survey result DB 102 is a database for storing results of a questionnaire survey on customer satisfaction. FIG. 4 is a conceptual diagram illustrating the configuration of the customer satisfaction survey result DB 102. As illustrated in FIG. 4, the customer satisfaction survey result DB 102 includes a customer ID, a date of survey indicating the date on which a customer satisfaction survey was conducted, and a level of customer satisfaction. The level of customer satisfaction is obtained as follows. For example, a customer satisfaction survey for evaluating each of a plurality of questions using five grades is performed, and the average of the evaluation values of all the questions is used as the level of satisfaction of the customer when the survey was conducted. The level of customer satisfaction described above is merely an example, and a result obtained by performing any other form of survey may be used if the result is information that numerically indicates a level of customer satisfaction.

### (c) Delivered-Machine DB 103

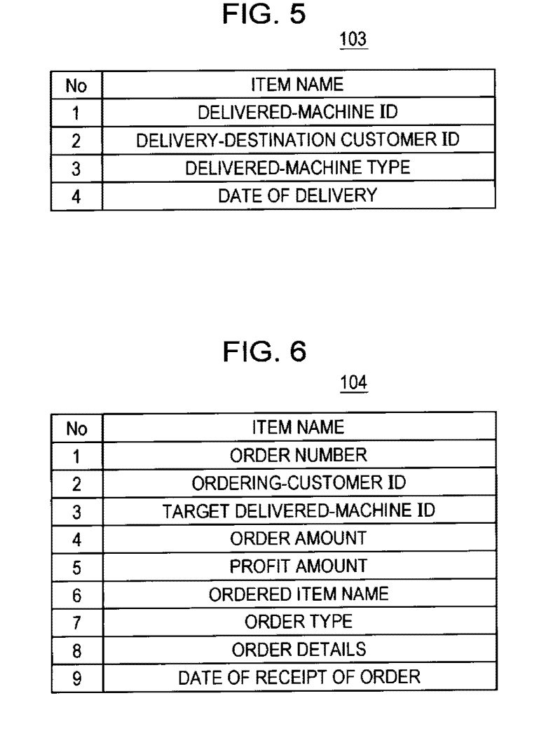

The delivered-machine DB 103 is a database for storing information concerning industrial machinery delivered to customers. FIG. 5 is a conceptual diagram illustrating the configuration of the delivered-machine DB 103. As illustrated in FIG. 5, the delivered-machine DB 103 includes a delivered-machine ID for identifying a piece of industrial machinery delivered to a customer (hereinafter referred to as a “delivered machine”), a delivery-destination customer ID for identifying a customer at the destination of the delivered machine, a delivered-machine type indicating the type of the delivered machine, and a date of delivery. The delivered-machine type is information indicating that, for example, when the piece of industrial machinery is a compressor, the type of the delivered compressor is a screw type, a reciprocating type, or a turbo-type. The date of delivery may be a date during the sales period of the delivered machine.

### (d) Order History DB 104

The order history DB 104 is a database for storing order history information concerning maintenance of industrial machinery. The order history DB 104 stores, for each order received, information concerning an order history. Orders received for a delivered machine include purchase of parts, equipment inspection, repair, and dispatch of technical staff to provide technical guidance, and a purchase of parts, an equipment inspection, a repair, or a dispatch of technical staff constitutes a single order.

FIG. 6 is a conceptual diagram illustrating the configuration of the order history DB 104. As illustrated in FIG. 6, the order history DB 104 includes an order number for identifying history data on a received order, an ordering-customer ID for identifying a customer who has placed the order, a target delivered-machine ID for identifying a delivered machine for which the order has been received, an order amount, a profit amount, an ordered item name, an order type, order details, and a date of receipt of the order. In the case of purchase of parts, the name of parts that have been purchased is set as the ordered item name. In the case of equipment inspection, the name of the inspected portion of the delivered machine or the name of the type of inspection is set as the ordered item name. In the case of repair, the name of the repaired portion of the delivered machine is set as the ordered item name. In the case of dispatch of technical staff, “technical staff dispatch” is set as the ordered item name. Examples of the order type include “parts purchase”, “construction including equipment inspection”, “new machine purchase”, and “others”. In the case of purchase of parts, “parts purchase” is set as the order type. In the case of equipment inspection and repair, “construction including equipment inspection” is set as the order type. In the case where a new machine is purchased, “new machine purchase” is set as the order type. In the case of dispatch of technical staff and provision of technical information, “others” is set as the order type. The order details represent text data indicating the content of a received order.

### (e) Ranking Result DB 105

The ranking result DB 105 is a database for storing information concerning results obtained when customers are ranked. In this system, customers are ranked. Ranking is performed by assigning rank values 1 to 5 to customers in accordance with order histories for the customers during a certain period. Rank value 1 is the best level and the level decreases as the rank value increases. The customers are categorized into a plurality of groups in accordance with their characteristics. Ranking is performed on a group-by-group basis. The period during which ranking is performed (hereinafter referred to as the “target order-receiving period”) is identified by designating the start date and the end date of the period. The details of the ranking process will be described below.

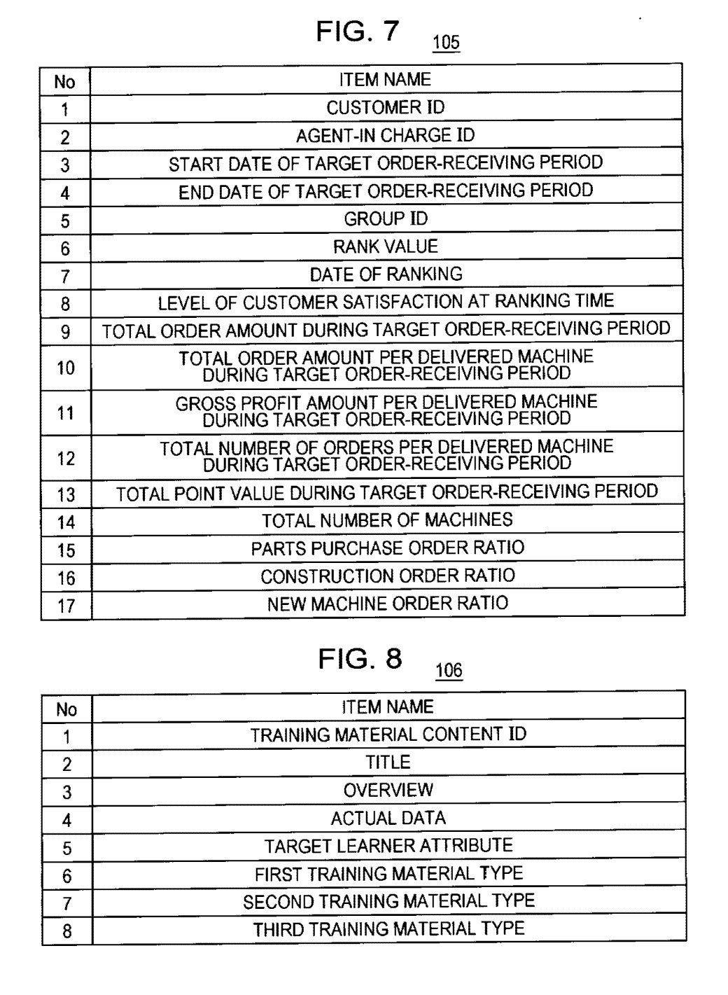

FIG. 7 is a conceptual diagram illustrating the configuration of the ranking result DB 105. As illustrated in FIG. 7, the ranking result DB 105 includes a customer ID, an agent-in-charge ID, the start date of a target order-receiving period indicating the date on which the target order-receiving period starts, the end date of the target order-receiving period indicating the date on which the target order-receiving period ends, a group ID for identifying a group to which the corresponding customer is assigned, a rank value indicating a ranking result, a date of ranking, a level of customer satisfaction at the time of ranking, a total order amount during the target order-receiving period, a total order amount per delivered machine during the target order-receiving period, a gross profit amount per delivered machine during the target order-receiving period, the total number of orders per delivered machine during the target order-receiving period, a total point value during the target order-receiving period, the total number of machines that is the number of delivered machines owned by the corresponding customer at the time of ranking, a parts purchase order ratio at the time of ranking, a construction order ratio at the time of ranking, and a new machine order ratio at the time of ranking. The level of customer satisfaction at the time of ranking is the most recent level of customer satisfaction when ranking is performed. The total order amount per delivered machine during the target order-receiving period is a value obtained by dividing the total order amount from the customer during the target order-receiving period by the number of delivered machines. The gross profit amount per delivered machine during the target order-receiving period is a value obtained by dividing the gross profit amount for the customer during the target order-receiving period by the number of delivered machines. The total number of orders per delivered machine during the target order-receiving period is a value obtained by dividing the total number of orders received from the customer during the target order-receiving period by the number of delivered machines. The parts purchase order ratio, the construction order ratio, and the new machine order ratio respectively represent the proportions of the total purchase amount of parts, the construction amount, and the purchase amount of new machines in the total order amount. The total point value will be described below.

### (f) Training Material Content DB 106

The training material content DB 106 is a database for storing content of training materials for maintenance of industrial machinery. FIG. 8 is a conceptual diagram illustrating the configuration of the training material content DB 106. As illustrated in FIG. 8, the training material content DB 106 includes a training material content ID for identifying training material content, the title of the training material content, an overview of the training material content, the actual data of the training material content, a target learner attribute for the training material content, and first to third training material types. In the overview of the training material content, keywords related to the training material content are listed. Examples of the actual data of the training material content include a document file such as a Portable Document Format (PDF) file, a video file of a moving image or a still image, an audio file, and drawing data. The target learner attribute indicates the attribute of persons to which the training material is to be provided for learning and is identified using three grades (the entry level, the intermediate level, and the senior level) used to evaluate the technical skill level of service personnel for maintenance services. More specifically, any level of service personnel among entry-level service personnel, intermediate-level service personnel, and senior-level service personnel or all levels of service personnel are set as the target learner attribute. The first to third training material types indicate types of training material content. Examples of the first training material type include “strengthening of sales of parts”, “strengthening of construction orders”, and “strengthening of sales of new machines”. Examples of the second training material type include “sales period” and “machine type”. Examples of the third training material type include “customer attribute (the rank of the customer or the level of customer satisfaction)”. In the first training material type, reference values of the parts purchase order ratio, the construction order ratio, and the new machine order ratio are associated with “strengthening of sales of parts”, “strengthening of construction orders”, and “strengthening of sales of new machines”, respectively. The reference values are each set on a plurality of levels, for example, the amounts of 10,000,000 yen, 30,000,000 yen, and 50,000,000 yen, and are determined so that training material content to be received by service personnel of each level in the agent can be identified. Thus, among the training material content for “strengthening of sales of parts”, training material content intended for agents for which the parts purchase order ratio corresponds to about 30,000,000 yen can be identified, for example.

The content of the training material content DB 106 is updated with the most recent one, as appropriate.

### (g) Agent DB 107

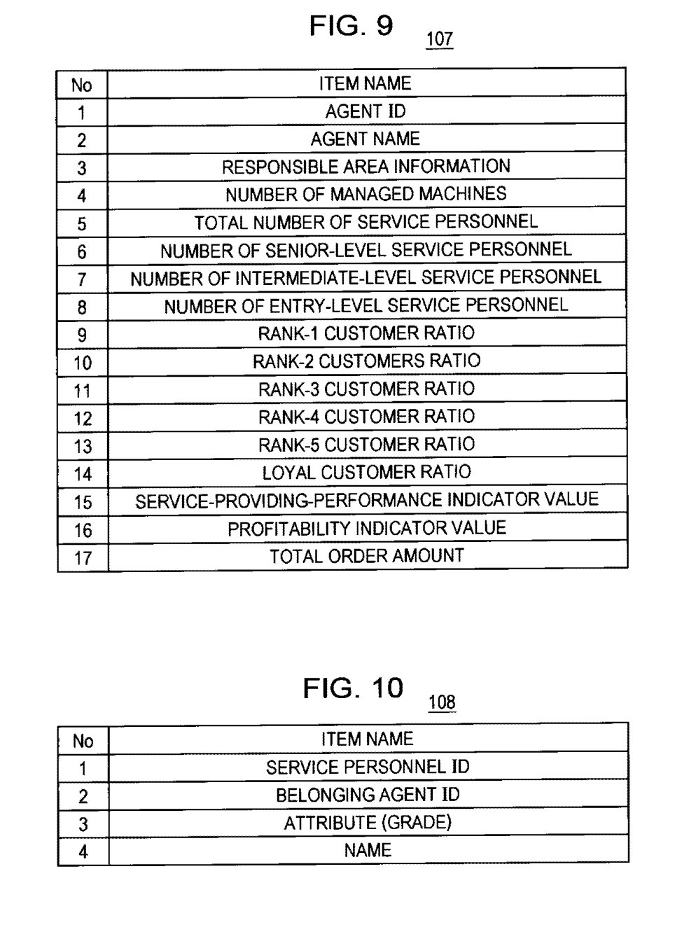

The agent DB 107 is a database for storing information concerning agents. FIG. 9 is a conceptual diagram illustrating the configuration of the agent DB 107. As illustrated in FIG. 9, the agent DB 107 includes an agent ID, an agent name, responsible area information for identifying an area for which the corresponding agent is responsible, the number of managed machines that represents the number of machines eligible to receive maintenance services provided by the agent, the total number of service personnel that represents the total number of service personnel belonging to the agent, the number of senior-level service personnel that represents the total number of senior-level service personnel belonging to the agent, the number of intermediate-level service personnel that represents the total number of intermediate-level service personnel belonging to the agent, the number of entry-level service personnel that represents the total number of entry-level service personnel belonging to the agent, a rank-1 customer ratio, a rank-2 customer ratio, a rank-3 customer ratio, a rank-4 customer ratio, a rank-5 customer ratio, a loyal customer ratio, a service-providing-performance indicator value, a profitability indicator value, and a total order amount. The rank-1 to rank-5 customer ratios are values obtained as a result of ranking customers in a way described below and respectively represent the proportions of rank-1 to rank-5 customers in all the customers of the agent. The loyal customer ratio (the proportion of good customers) indicates the proportion of customers ranked high in all of the customers of the agent and is, in this embodiment, a value obtained by integration of the rank-1 to rank-3 customer ratios. The service-providing-performance indicator value and the profitability indicator value will be described below. The total order amount is the total order amount placed in orders received by the agent during the target order-receiving period. The ranking of customers is performed repeatedly at certain intervals. The loyal customer ratio, the service-providing-performance indicator value, the profitability indicator value, and the total order amount, which are stored in the agent DB 107, are values calculated from the most recent results of ranking the customers.

### (h) Service Personnel DB 108

The service personnel DB 108 is a database for storing information concerning service personnel. FIG. 10 is a conceptual diagram illustrating the configuration of the service personnel DB 108. As illustrated in FIG. 10, the service personnel DB 108 includes a service personnel ID, a belonging agent ID for identifying an agent to which each service person belongs, the grade of the service person, and the name of the service person. As described above, the grade of a service person is a value determined as a result of evaluating the technical skill level of the service person for maintenance services by using any one of the three grades, namely, the entry level, the intermediate level, and the senior level. The grade of a service person is determined using their achievements and experience in maintenance services, their skill, their acquired qualification, and so on and is set using evaluation at predetermined intervals (for example, at intervals of one year to three years).

### Operation of Human Resource Development Support System

Next, the operation of the human resource development support system having the configuration described above will be described with reference to a flowchart.

### 1. Rank Setting Process

The human resource development support system (the server 1) ranks customers regularly (for example, at intervals of one year) or irregularly.

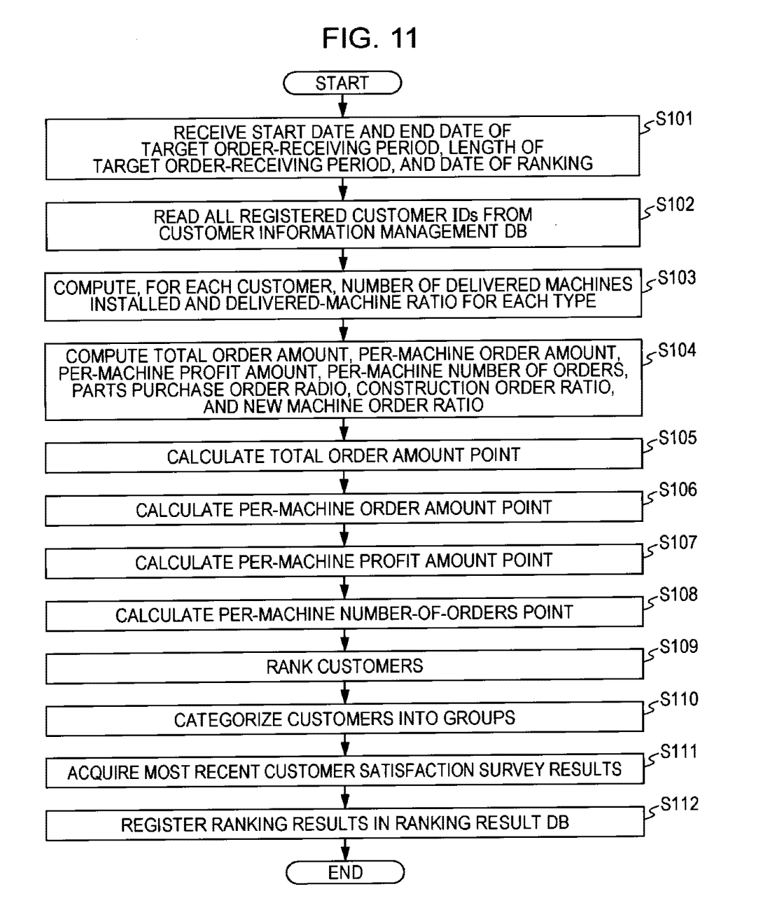

FIG. 11 is a flowchart illustrating a processing procedure of a rank setting process executed by the human resource development support system (the server 1) according to the embodiment of the present invention. When executing the rank setting process, an operator operates the input unit 13 of the server 1 to input to the server 1 the start date and the end date of the target order-receiving period, the length of the target order-receiving period, and the date of ranking. The operator may input the information described above to the server 1 by using one of the terminal devices 2 instead of the input unit 13. The server 1 receives the input of the start date and the end date of the target order-receiving period, the length of the target order-receiving period, and the date of ranking (S101).

Then, the CPU 11a of the server 1 reads all of the registered customer IDs from the customer information management DB 101 (S102). The CPU 11a searches the delivered-machine DB 103 by using the read customer IDs as the key and computes, for each customer, the number of delivered machines installed and a delivered-machine ratio for each type (S103).

The CPU 11a searches the order history DB 104 by using the customer IDs as the key and computes the following items for each customer (S104):

(1) the total order amount during the target order-receiving period;

(2) the total order amount per delivered machine during the target order-receiving period;

(3) the gross profit amount per delivered machine during the target order-receiving period;

(4) the total number of orders per delivered machine during the target order-receiving period;

(5) the parts purchase order ratio during the target order-receiving period;

(6) the construction order ratio during the target order-receiving period; and

(7) the new machine order ratio during the target order-receiving period.

The parts purchase order ratio is a percentage of how much of the total order amount the total purchase amount of parts occupies. The construction order ratio is a percentage of how much of the total order amount the total order amount of constructions including equipment inspection (the sum of the order amounts of constructions including equipment inspection and repair) occupies. The new machine order ratio is a percentage of how much of the total order amount the purchase amount of new machines occupies.

The CPU 11a calculates a total order amount point by using the total order amount calculated in S104 (S105). The total order amount point is calculated using any of the following formulas depending on whether the total order amount is greater than or equal to a threshold Amax.

Total order amount point=total order amount÷Amax×Arange (in the case where the total order amount is less than Amax)

Total order amount point=Arange (in the case where the total order amount is greater than or equal to Amax)

In the formulas above, Arange denotes the upper limit of the total order amount point. For example, Amax is 500,000,000 yen and Arange is 150. In this case, if the total order amount is 300,000,000 yen, the total order amount point is 90, and, if the total order amount is 600,000,000 yen, the total order amount point is 150. Alternatively, the total order amount point may not be calculated using separate formulas depending on the cases described above, but all total order amount points may be calculated using the formula described above for the case where “the total order amount is less than Amax”.

The CPU 11a uses the total order amount per delivered machine (hereinafter referred to as the “per-machine order amount”), which is calculated in S104, to calculate a per-machine order amount point (S106). The per-machine order amount point is calculated using any of the following formulas depending on whether the per-machine order amount is greater than or equal to a threshold Bmax.

Per-machine order amount point=per-machine order amount÷Bmax×Brange (in the case where the per-machine order amount is less than Bmax)

Per-machine order amount point=Brange (in the case where the per-machine order amount is greater than or equal to Bmax)

In the formulas above, Brange denotes the upper limit of the per-machine order amount point. Alternatively, the per-machine order amount point may not be calculated using separate formulas depending on the cases described above, but all per-machine order amount points may be calculated using the formula described above for the case where “the per-machine order amount is less than Bmax”.

The CPU 11a uses the gross profit amount per delivered machine (hereinafter referred to as the “per-machine profit amount”), which is calculated in S104, to calculate a per-machine profit amount point (S107). The per-machine profit amount point is calculated using any of the following formulas depending on whether the per-machine profit amount is greater than or equal to a threshold Cmax.

Per-machine profit amount point=per-machine profit amount÷Cmax×Crange (in the case where the per-machine profit amount is less than Cmax)

Per-machine profit amount point=Crange (in the case where the per-machine profit amount is greater than or equal to Cmax)

In the formulas above, Crange denotes the upper limit of the per-machine profit amount point. Alternatively, the per-machine profit amount point may not be calculated using separate formulas depending on the cases described above, but all per-machine profit amount points may be calculated using the formula described above for the case where “the per-machine profit amount is less than Cmax”.

The CPU 11a uses the total number of orders per delivered machine (hereinafter referred to as the “per-machine number of orders”), which is calculated in S104, to calculate a per-machine number-of-orders point (S108). The per-machine number-of-orders point is calculated using any of the following formulas depending on whether the per-machine number of orders is greater than or equal to a threshold Dmax.

Per-machine number-of-orders point=per-machine number of orders÷Dmax×Drange (in the case where the per-machine number of orders is less than Dmax)

Per-machine number-of-orders point=Drange (in the case where the per-machine number of orders is greater than or equal to Dmax)

In the formulas above, Drange denotes the upper limit of the per-machine number-of-orders point. Alternatively, the per-machine number-of-orders point may not be calculated using separate formulas depending on the cases described above, but all per-machine number-of-orders points may be calculated using the formula described above for the case where “the per-machine number of orders is less than Dmax”.

The CPU 11a ranks the customers by using the points calculated in S105 to S108 (S109). Specifically, the customers are ranked in accordance with which of the following criteria the total point value obtained by integration of the total order amount point, the per-machine order amount point, the per-machine profit amount point, and the per-machine number-of-orders point for each customer meets.

Rank 1: total point value≧Xrange×0.8

Rank 2: total point value≧Xrange×0.6

Rank 3: total point value≧Xrange×0.4

Rank 4: total point value≧Xrange×0.2

Rank 5: total point value<Xrange×0.2

The upper limit)(range of the total point value is given by the following formula.

Xrange=Arange+Brange+Crange+Drange

Then, the CPU 11a categorizes the customers into a plurality of groups (S110) by using the number of delivered machines installed and the delivered-machine ratio for each type, which are computed in S103, and by using the parts purchase order ratio and the construction order ratio, which are calculated in S104.

A description will be given of grouping in S110. The customers are divided into groups in terms of the following three viewpoints. It is assumed here that three types of delivered machines A, B, and C are present.

Viewpoint 1: the constitution of the delivered machines owned by each customer

(1) The delivered machines are constituted by mainly the delivered machines A (the delivered machines A account for 70% or more of all the owned delivered machines).

(2) The delivered machines are constituted by mainly the delivered machines B (the delivered machines B account for 70% or more of all the owned delivered machines).

(3) The delivered machines are constituted by mainly the delivered machines C (the delivered machines C account for 70% or more of all the owned delivered machines).

(4) The delivered machines are constituted by a plurality of types of delivered machines (other than (1) to (3) described above)

Viewpoint 2: the number of delivered machines installed

(1) The number of delivered machines installed is small (the number of delivered machines installed is less than or equal to 5).

(2) The number of delivered machines installed is slightly large (the number of delivered machines installed is greater than or equal to 6 and less than or equal to 15).

(3) The number of delivered machines installed is large (the number of delivered machines installed is greater than or equal to 16).

Viewpoint 3: the content of orders for maintenance

(1) Orders for mainly replacement parts are placed (the parts purchase order ratio is greater than or equal to 70%).

(2) Orders for mainly equipment-inspection construction are placed (the construction order ratio is greater than or equal to 70%).

(3) Orders for both replacement parts and equipment-inspection construction are placed (other than (1) and (2) described above).

In S110, the CPU 11a categorizes the customers into 36 groups based on the three viewpoints described above. Accordingly, the customers are divided into five ranks for each of the 36 groups.

Then, the CPU 11a searches the customer satisfaction survey result DB 102 by using the customer IDs as the key to acquire the most recent customer satisfaction survey results for each customer (S111). Further, the CPU 11a registers the results of ranking which are obtained through the process described above in the ranking result DB 105 (S112). Then, the rank setting process ends.

### 2. KPI Value Calculation Process

Next, a key performance indicator (KPI) value calculation process for calculating a KPI value will be described. In this embodiment, two KPI values, namely, a service-providing-performance indicator value and a profitability indicator value, are calculated and are used as references for supporting human resource development.

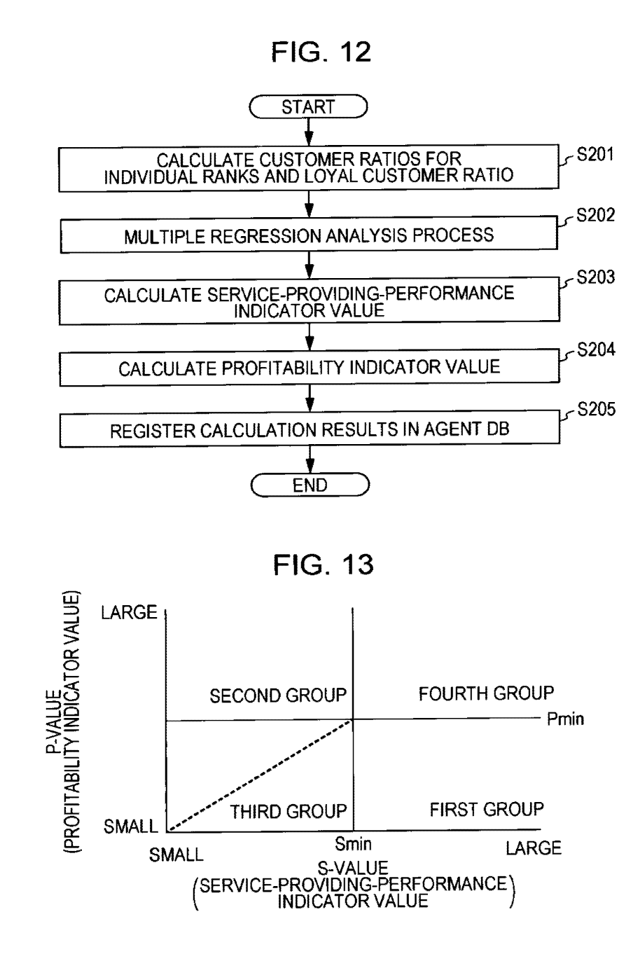

FIG. 12 is a flowchart illustrating a processing procedure of a KPI value calculation process executed by the human resource development support system (the server 1) according to the embodiment of the present invention. The CPU 11a calculates, for each agent, customer ratios for the individual ranks and a loyal customer ratio (S201). The ratios described above are calculated using the information registered in the ranking result DB 105 through the rank setting process described above in accordance with the following formulas.

Rank-1 customer ratio=(number of customers assigned rank 1 among all customers of corresponding agent)/(total number of customers of corresponding agent)×100 (1)

Rank-2 customer ratio=(number of customers assigned rank 2 among all customers of corresponding agent)/(total number of customers of corresponding agent)×100 (2)

Rank-3 customer ratio=(number of customers assigned rank 3 among all customers of corresponding agent)/(total number of customers of corresponding agent)×100 (3)

Rank-4 customer ratio=(number of customers assigned rank 4 among all customers of corresponding agent)/(total number of customers of corresponding agent)×100 (4)

Rank-5 customer ratio=(number of customers assigned rank 5 among all customers of corresponding agent)/(total number of customers of corresponding agent)×100 (5)

Loyal customer ratio=rank-1 customer ratio+rank-2 customer ratio+rank-3 customer ratio (6)

Then, the CPU 11a creates a multiple regression equation for sales projection that includes the total order amount during the target order-receiving period, which is the projected sales amount, as the target variable and the numbers of service personnel for the individual grades and the loyal customer ratio as explanatory variables, and performs a multiple regression analysis process using the multiple regression equation for sales projection (S202). Thus, the coefficients (a to d) of the explanatory variables are calculated. The multiple regression equation for sales projection is given by

y=ax₁+bx₂+cx₃+dx₄+e,

where y denotes the sales projection, x₁ denotes the number of entry-level service personnel, x₂ denotes the number of intermediate-level service personnel, x₃ denotes the number of senior-level service personnel, x₄ denotes the loyal customer ratio, and e denotes the probable error.

The CPU 11a calculates, for each agent, a service-providing-performance indicator value by using the coefficients of the explanatory variables obtained in the way described above and by using the following formula (S203).

Service-providing-performance indicator value=a×number of entry-level service personnel+b×number of intermediate-level service personnel×c+number of senior-level service personnel

The CPU 11a further calculates, for each agent, a profitability indicator value by using the coefficients of the explanatory variables in the way described above and by using the following formula (S204).

Profitability indicator value=d×loyal customer ratio

Through the process described above, the service-providing-performance indicator values and the profitability indicator values, which are KPI values, are obtained for the individual agents. The CPU 11a registers the calculation results in the agent DB 107 (S205). Then, the KPI value calculation process ends.

### 3. Grouping Process

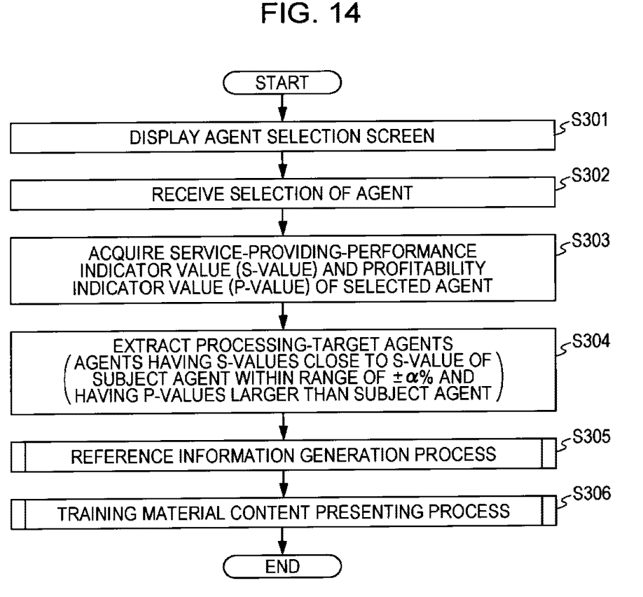

A grouping process for dividing agents into groups is executed by using the service-providing-performance indicator values and the profitability indicator values obtained in the way described above. In this embodiment, an S-P scatter diagram based on the KPI values, with the x axis denoting the service-providing-performance indicator values (S-values) and the y axis denoting the profitability indicator values (P-values), is developed in the CPU 11a, and the agents are divided into groups in accordance with which region on the S-P scatter diagram each agent is plotted. FIG. 13 illustrates an image of the S-P scatter diagram. In this embodiment, the region where S-value≧Sₘᵢₙ and P-value<Pₘᵢₙ are satisfied is referred to as a first group, the region where S-value<Sₘᵢₙ and P-value Pₘᵢₙ are satisfied is referred to as a second group, the region where S-value<Sₘᵢₙ and P-value<are satisfied is referred to as a third group, and the region where S-value≧Sₘᵢₙ and P-value≧Pₘᵢₙ are satisfied is referred to as a fourth group. Each of the agents is included in any of the first to fourth groups on the basis of the S-value and the P-value thereof. Sₘᵢₙ and Pₘᵢₙ are respectively a minimum S-value and a minimum P-value that are respectively set as appropriate with reference to the S-values and the P-values calculated for the individual agents.

### 4. Human Resource Development Support Process

Next, a human resource development support process for supporting creating a plan for training and development of service personnel will be described. The human resource development support process includes a first human resource development support process intended mainly for improving profitability and a second human resource development support process intended mainly for enhancing service providing performance.

An agent categorized in the first group as a result of the grouping process described above is considered to have a certain level or more of service providing performance but have an unsatisfactory level of profitability. The reason for this is that it is anticipated that appropriate service personnel would have failed to perform appropriate sales activities in accordance with customer loyalty (customer's sense of loyalty) to the agent. In this case, at least one of the following measures is considered to be taken to improve profitability: (a) improving services to be provided for customer loyalty, (b) improving the personal leverage ratio (the ratio of the number of entry-level and intermediate-level service personnel per senior-level service person), and (c) improving the quality of service personnel. For an agent categorized in the first group, therefore, an agent group having service-providing-performance indicator values substantially equal to the service-providing-performance indicator value of the agent and having higher profitability than the agent is extracted. In addition, (a) the difference in the customer segment on which the focus is placed and (b) the difference in personal leverage ratio are provided, and (c) the grade of service personnel for which human resource development is to be strengthened, which is estimated from the differences described above, is identified. Training material content intended for the identified grade is provided. The processes described above are executed in the first human resource development support process.

An agent categorized in the second group is considered to have a certain level or more of profitability but have an unsatisfactory level of service providing performance. In this case, to further increase profitability, at least one of the following measures is considered to be taken: (a) improving the personal leverage ratio, (b) improving the number of service personnel required, and (c) improving the quality of service personnel. For an agent categorized in the second group, therefore, an agent group having higher profitability than the agent is extracted. In addition, (a) the difference in a customer segment on which the focus is placed and (b) the difference in personal leverage ratio are provided with reference to the difference in the number of required service personnel of the agent, the number of managed machines of the agent, and so on, and (c) the grade of service personnel for which human resource development is to be strengthened, which is estimated from the differences described above, is identified. Training material content intended for the identified grade is provided. The processes described above are executed in the second human resource development support process.

An agent categorized in the third group is considered to be unsatisfactory in terms of both profitability and service providing performance. In this case, the first human resource development support process is performed for agents plotted in a region to the lower right of a line connecting the origin and the intersection point of Sₘᵢₙ and Pₘᵢₙ on the S-P scatter diagram (the broken line in FIG. 13), and the second human resource development support process is performed for agents plotted on the line and in a region to the upper left of the line.

An agent categorized in the fourth group is an agent whose profitability and service providing performance are greater than or equal to certain reference values Sₘᵢₙ and Pₘᵢₙ). In this case, within an agent group belonging to the fourth group, agents that are assigned higher profitability indicator value than the agent and that manage more machines than the agent are extracted, and different human resource development support processes are used depending on whether the number of extracted agents is greater than or equal to a predetermined number (for example, whether the ratio of the number of extracted agents to the total number of agents belonging to the fourth group is greater than or equal to a predetermined value). If the number of extracted agents is greater than or equal to the predetermined number, the second human resource development support process is performed for the agent. If the number of extracted agents is smaller than the predetermined number, the first human resource development support process is performed for the agent.

The details of the first and second human resource development support processes will be described hereinafter.

### 4-1. First Human Resource Development Support Process

FIG. 14 is a flowchart illustrating a processing procedure of the first human resource development support process executed by the human resource development support system (the server 1) according to the embodiment of the present invention.

In each agent, a person in charge of human resource development can operate the terminal device 2 to send an instruction to the human resource development support system (the server 1) to start the first human resource development support process. Upon receipt of the instruction, the CPU 11a generates information for displaying an agent selection screen and transmits the generated information to the terminal device 2, which has requested the display of the agent selection screen, to display the agent selection screen on the terminal device 2 (S301).

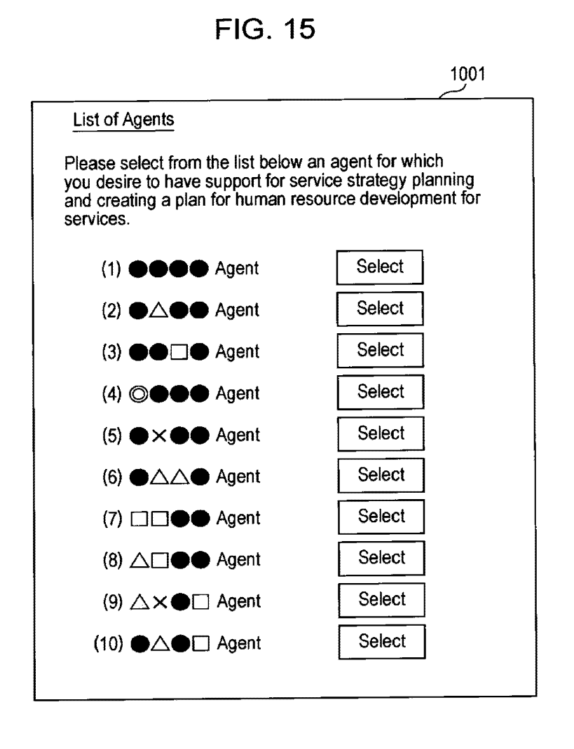

FIG. 15 is a diagram illustrating an example of the agent selection screen. As illustrated in FIG. 15, on an agent selection screen 1001, the names of agents and buttons each for selecting the corresponding one of the agents are displayed arranged vertically. The person in charge of human resource development clicks on the button for selecting the subject agent to which the person in charge of human resource development belongs to send an instruction to execute a human resource development support process suitable for the subject agent.

Upon receipt of the selection of an agent in the way described above (S302), the CPU 11a acquires from the agent DB 107 the service-providing-performance indicator value (S-value) and the profitability indicator value (P-value) of the selected agent (hereinafter referred to as the “subject agent”) (S303).

Then, the CPU 11a extracts, from the agent DB 107, agents having S-values close to the S-value of the subject agent within a range of ±α% and having P-values larger than the subject agent to obtain processing-target agents (S304). The value a is set as appropriate in accordance with the form and size of the business to which this system is applied. The processing-target agents are a collection of agents that are models to be referenced by the subject agent. By using various information related to the processing-target agents, the CPU 11a executes a reference information generation process described below (S305).

### 4-1-1. Reference Information Generation Process

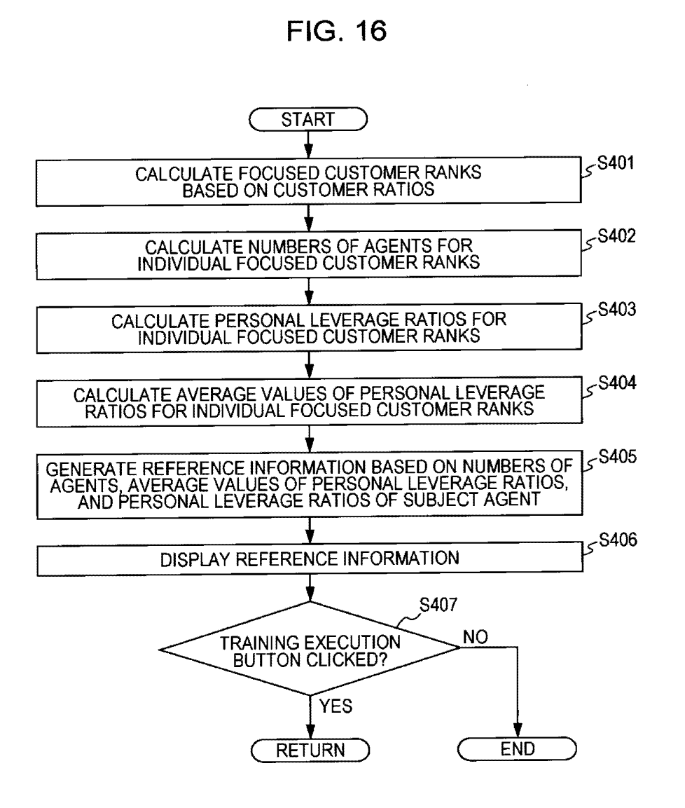

FIG. 16 is a flowchart illustrating a processing procedure of a reference information generation process executed by the human resource development support system (the server 1) according to the embodiment of the present invention.

On the basis of the customer ratios of the processing-target agent group, the CPU 11a calculates focused customer ranks that are customer ranks on which the individual agents place the focus (S401). Specifically, the calculation of the focused customer ranks is performed in the following way. First, the CPU 11a acquires, for each of the processing-target agents, customer ratios for the individual ranks (the rank-1 customer ratio to the rank-5 customer ratio) from the agent DB 107. Then, the CPU 11a identifies, for each agent, the rank having the highest customer ratio and sets the identified rank as the focused customer rank. If there are ranks having the same customer ratio, the highest rank is set as the focused customer rank.

The CPU 11a calculates the numbers of agents for the individual focused customer ranks on the basis of the results obtained in S401 (S402).

Then, the CPU 11a acquires, from the agent DB 107, the numbers of senior-level, intermediate-level, and entry-level service personnel in each of the processing-target agents and calculates personal leverage ratios for each focused customer rank on the basis of the numbers of senior-level, intermediate-level, and entry-level service personnel (S403). Specifically, the personal leverage ratios are calculated using the following formulas.

Personal leverage ratio A=(number of intermediate-level service personnel+number of entry-level service personnel)/number of senior-level service personnel

Personal leverage ratio B=number of intermediate-level service personnel/number of senior-level service personnel

Personal leverage ratio C=number of entry-level service personnel/number of senior-level service personnel

The personal leverage ratios described above are expressed in “persons”.

On the basis of the personal leverage ratios A to C for the individual agents, which are calculated in S403, the CPU 11a calculates the average values of the personal leverage ratios A to C for the individual focused customer ranks (S404).

Then, the CPU 11a generates reference information to be used as a reference for human resource development, on the basis of the numbers of agents for the individual focused customer ranks, which are calculated in S402, the average values of the personal leverage ratios A to C for the individual focused customer ranks, which are calculated in S404, and the personal leverage ratios A to C of the subject agent (S405). Then, the CPU 11a generates information for displaying the reference information and transmits the generated information to the terminal device 2 to display a screen showing the reference information on the terminal device 2 (S406).

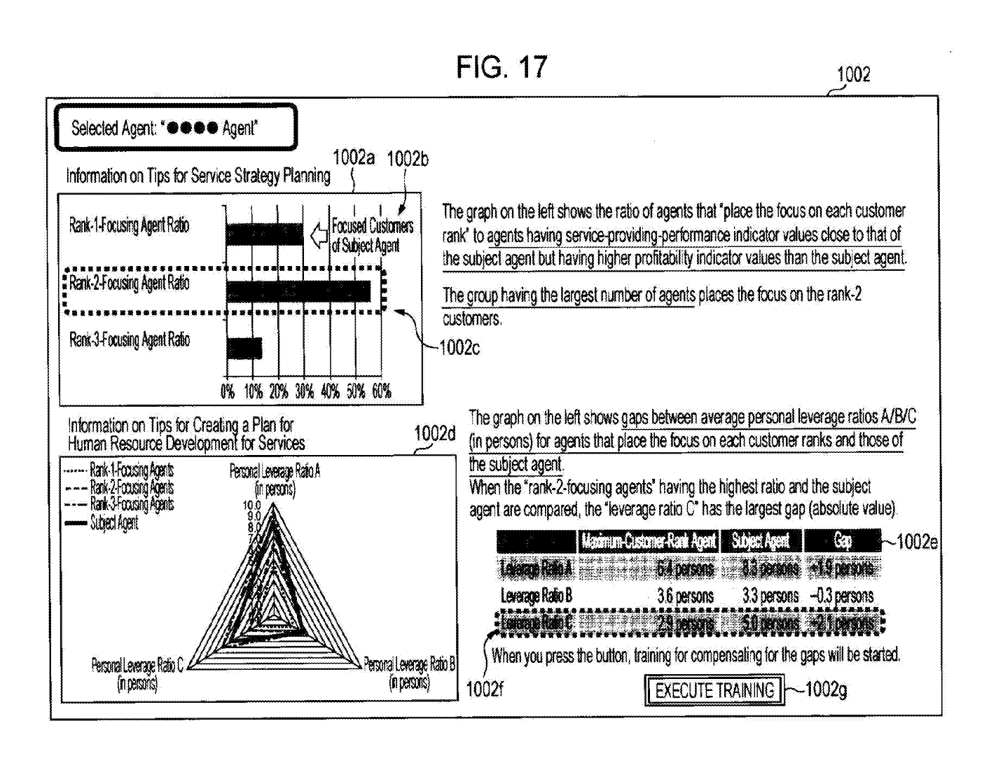

FIG. 17 is a diagram illustrating an example of a reference information display screen. As illustrated in FIG. 17, generally, the following two types of information are displayed on a reference information display screen 1002:

(1) information concerning customers to be targeted in sales activities for maintenance services (“information on tips for service strategy planning”); and

(2) information concerning the constitution of service personnel (“information on tips for creating a plan for human resource development for services”).

In the “information on tips for service strategy planning”, the ratios of agents that place the focus on the individual customer ranks to the processing-target agents (the proportions of the numbers of agents that place the focus on the individual customer ranks in the number of processing-target agents) are represented using a bar graph 1002a. The bar graph 1002a also contains information 1002b for identifying the focused customer rank of the subject agent and information 1002c for identifying the focused customer rank having the highest agent ratio. A group of agents that place the focus on the customer rank having the highest agent ratio is hereinafter referred to as a “most-focused-customer-rank agent group”. The example illustrated in FIG. 17 demonstrates that, whereas the subject agent places the focus on the rank-1 customers, many of other agents having service providing performances similar to the service providing performance of the subject agent and having higher profitability than the subject agent place the focus on the rank-2 customers. Thus, for example, a customer rank to be targeted in sales activities for maintenance services in the future can be understood.

Additionally, the “information on tips for service strategy planning” may provide quantitative information on the subject agent and the most-focused-customer-rank agent group, such as the order amounts (for example, the average total order amounts, the average total order amounts per machine, the average gross profit amounts per machine, the average total numbers of orders, the average total numbers of machines, the average parts purchase order ratios, the average construction order ratios, the average new machine order ratios, etc.).

Referring to FIG. 17, in the “information on tips for creating a plan for human resource development for services”, a graph 1002d is provided for comparing the average values of the personal leverage ratios A to C for the individual focused customer ranks in the processing-target agents with the personal leverage ratios A to C of the subject agent. A table 1002e is also depicted in which the average values of the personal leverage ratios A to C in the most-focused-customer-rank agent group (in FIG. 17, the rank 2), the personal leverage ratios A to C of the subject agent, and the differences (gaps) therebetween are associated with one another. The table 1002e also contains information 1002f for identifying the leverage ratio having the largest gap. In the example illustrated in FIG. 17, when the agent group to be used as models (the agent group that places the focus on the rank-2 customers) is compared with the subject agent, the gap in the leverage ratio C is large, namely, +2.1 persons. Since the leverage ratio C represents the number of entry-level service personnel per senior-level service person, the illustrated example demonstrates that training for increasing the grade of entry-level service personnel is necessary to compensate for the gap. As described above, by referring to the “information on tips for creating a plan for human resource development for services”, it is possible to identify the grade of service personnel for which human resource development is to be strengthened. There are also gaps in the leverage ratios A and B, which can also be used as references for human resource development.

The reference information display screen 1002 provides a button 1002d for sending an instruction to execute training to compensate for the gaps described above. A person in charge of human resource development clicks on the button 1002d when they desire to execute training.

When a click on the button 1002d is detected (YES in S407), the CPU 11a executes a training material content presenting process described below (S306). If no click on the button 1002d is detected (NO in S407), the process ends.

### 4-1-2. Training Material Content Presenting Process

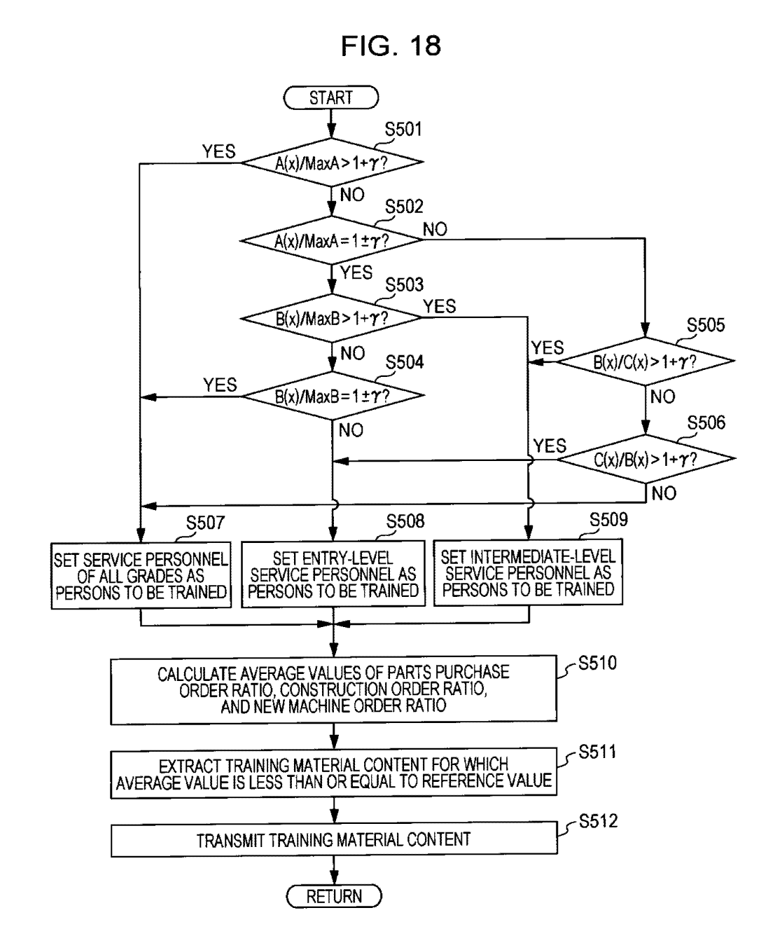

FIG. 18 is a flowchart illustrating a processing procedure of a training material content presenting process executed by the human resource development support system (the server 1) according to the embodiment of the present invention.

In the training material content presenting process, the grade of a person to be trained is identified on the basis of the following values.

A(x): the personal leverage ratio A of the subject agent

B(x): the personal leverage ratio B of the subject agent

C(x): the personal leverage ratio C of the subject agent

MaxA: the average value of the personal leverage ratios A in the most-focused-customer-rank agent group

MaxB: the average value of the personal leverage ratios B in the most-focused-customer-rank agent group

MaxC: the average value of the personal leverage ratios C in the most-focused-customer-rank agent group

The CPU Ha determines whether A(x)/MaxA is greater than 1+γ (S501). The value γ is set as appropriate in accordance with the form and size of the business to which this system is applied. If it is determined that A(x)/MaxA is greater than 1+γ (YES in S501), the process proceeds to S507 described below. On the other hand, if it is determined that A(x)/MaxA is not greater than 1+γ (NO in S501), the CPU 11a determines whether A(x)/MaxA is equal to 1±γ (S502).

If it is determined in S502 that A(x)/MaxA is equal to 1±γ (YES in S502), the CPU 11a determines whether B(x)/MaxB is greater than 1+γ (S503). If it is determined that B(x)/MaxB is greater than 1+γ (YES in S503), the process proceeds to S509 described below. On the other hand, if it is determined that B(x)/MaxB is not greater than 1+γ (NO in S503), the CPU 11a determines whether B(x)/MaxB is equal to 1±γ (S504). If it is determined that B(x)MaxB is equal to 1±γ (YES in S504), the process proceeds to S507 described below. If it is determined that B(x)/MaxB is not equal to 1±γ (NO in S504), the process proceeds to S508 described below.

If it is determined in S502 that A(x)/MaxA is not equal to 1±γ (NO in S502), the CPU 11a determines whether B(x)/C(x) is greater than 1+γ (S505). If it is determined that B(x)/C(x) is greater than 1+γ (YES in S505), the process proceeds to S509 described below. On the other hand, if it is determined that B(x)/C(x) is not greater than 1+γ (NO in S505), the CPU 11a determines whether C(x)/B(x) is greater than 1+γ (S506). If it is determined that C(x)/B(x) is greater than 1+γ (YES in S506), the process proceeds to S508 described below. If it is determined that C(x)/B(x) is not greater than 1+γ (NO in S506), the process proceeds to S507 described below.

In S507, the CPU 11a sets service personnel of all the grades, namely, the entry level, the intermediate level, and the senior level, as persons to be trained. In S508, the CPU 11a sets entry-level service personnel as persons to be trained. In S509, the CPU 11a sets intermediate-level service personnel as persons to be trained.

Then, the CPU 11a refers to the agent DB 107 and calculates the average values of the parts purchase order ratio, the construction order ratio, and the new machine order ratio in the most focused-customer-rank agent group (S510). The CPU 11a compares the calculated average values with the respective reference values associated with the training material types in the training material content DB 106 and extracts from the training material content DB 106 training material content for which the average values are less than or equal to the reference values and which has, as the target learner attribute, the grade set in any of steps S507 to S509 as that of the persons to be trained (S511). For example, if the average value of the construction order ratio is 30,000,000 yen, training material content having the training material type “strengthening of construction orders” with which the reference value of less than or equal to 30,000,000 yen is associated is extracted. The CPU 11a transmits the extracted training material content to the terminal device 2 via the communication interface 11g (S512).

In the training material content presenting process described above, appropriate persons to be trained and training material content can be automatically identified by comparing a most-focused-customer-rank agent group to be used as models for the subject agent with the subject agent. This enables appropriate training to be easily performed.

### 4-2. Second Human Resource Development Support Process

Next, the second human resource development support process will be described.

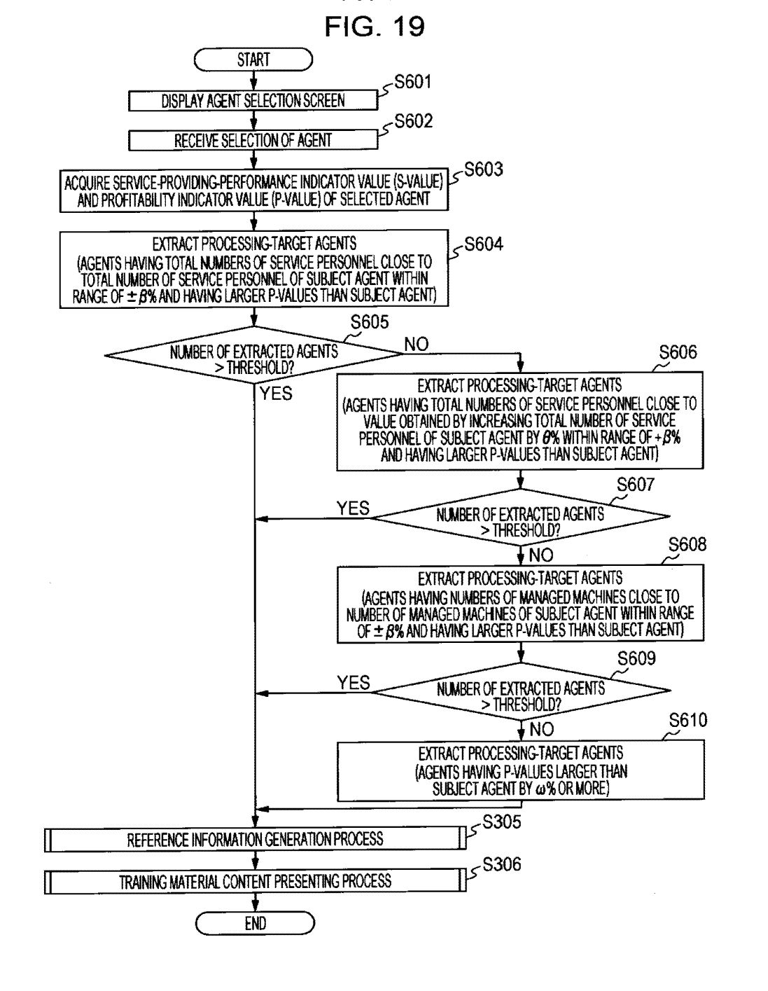

FIG. 19 is a flowchart illustrating a processing procedure of the second human resource development support process executed by the human resource development support system (the server 1) according to the embodiment of the present invention.

As in the first human resource development support process, the CPU l la generates information for displaying an agent selection screen and transmits the generated information to the terminal device 2, which has requested the display of the agent selection screen, to display the agent selection screen on the terminal device 2 (S601). In this case, the agent selection screen 1001 illustrated in FIG. 15 is displayed. A person in charge of human resource development clicks on a button for selecting the subject agent on the agent selection screen 1001 to send an instruction to execute a human resource development support process suitable for the subject agent.

Upon receipt of the selection of an agent in the way described above (S602), the CPU 11a acquires from the agent DB 107 the service-providing-performance indicator value (S-value) and the profitability indicator value (P-value) of the selected agent (the subject agent) (S603).

The CPU 11a extracts, from the agent DB 107, agents having total numbers of service personnel close to the total number of service personnel of the subject agent within a range of ±β% and having P-values larger than the subject agent to obtain processing-target agents (S604). Then, the CPU 11a determines whether the number of extracted agents is greater than a predetermined threshold (S605). If it is determined that the number of extracted agents is greater than the threshold (YES in S605), the CPU 11a executes the reference information generation process (S305) and the training material content presenting process (S306) described above. The reference information display screen obtained as a result of the reference information generation process in this case, which is not illustrated in the drawings, is similar to that illustrated in FIG. 17. In this case, the “information on tips for service strategy planning” provides, in a portion to the right of the bar graph 1002a, another statement such as “the graph on the left shows the ratio of agents that ‘place the focus on each customer rank’ to agents having total numbers of service personnel (numbers of service personnel required) close to that of the subject agent but having higher profitability than the subject agent”.

On the other hand, if it is determined in S605 that the number of extracted agents is not greater than the threshold (NO in S605), the CPU 11a extracts from the agent DB 107 agents having total numbers of service personnel close to a value obtained by increasing the total number of service personnel of the subject agent by 0% within a range of ±β% and having larger P-values than the subject agent to obtain processing-target agents (S606). The value θ is set as appropriate in accordance with the form and size of the business to which this system is applied. Then, the CPU 11a determines whether the number of extracted agents is greater than a predetermined threshold (S607). If it is determined that the number of extracted agents is greater than the threshold (YES in S607), the CPU 11a executes the reference information generation process (S305) and the training material content presenting process (S306) described above. The reference information display screen obtained as a result of the reference information generation process in this case, which is not illustrated in the drawings, is similar to that illustrated in FIG. 17. In this case, the “information on tips for service strategy planning” provides, in a portion to the right of the bar graph 1002a, another statement such as “the graph on the left shows the ratio of agents that ‘place the focus on each customer rank’ to agents having a size corresponding to a value obtained by increasing the present total number of service personnel by about 0% and having higher profitability than the subject agent”.

On the other hand, if it is determined in S607 that the number of extracted agents is not greater than the threshold (NO in S607), the CPU 11a extracts from the agent DB 107 agents having numbers of managed machines close to the number of managed machines of the subject agent within a range of ±β% and having P-values larger than the subject agent to obtain processing-target agents (S608). Then, the CPU 11a determines whether the number of extracted agents is greater than a predetermined threshold (S609). If it is determined that the number of extracted agents is greater than the threshold (YES in S609), the CPU 11a executes the reference information generation process (S305) and the training material content presenting process (S306) described above. The reference information display screen obtained as a result of the reference information generation process in this case, which is not illustrated in the drawings, is similar to that illustrated in FIG. 17. In this case, the “information on tips for service strategy planning” provides, in a portion to the right of the bar graph 1002a, another statement such as “the graph on the left shows the ratio of agents that ‘place the focus on each customer rank’ to agents having numbers of managed machines close to that of the subject agent but having higher profitability than the subject agent”.

On the other hand, if it is determined in S609 that the number of extracted agents is not greater than the threshold (NO in S609), the CPU 11a extracts from the agent DB 107 agents having P-values larger than the subject agent by ω% or more to obtain processing-target agents (S610) and executes the reference information generation process (S305) and the training material content presenting process (S306) described above. The value co is set as appropriate in accordance with the form and size of the business to which this system is applied. The reference information display screen obtained as a result of the reference information generation process in this case, which is not illustrated in the drawings, is similar to that illustrated in FIG. 17. In this case, the “information on tips for service strategy planning” provides, in a portion to the right of the bar graph 1002a, another statement such as “there is no agent having a number of service personnel required and a number of managed machines close to those of the subject agent and having higher profitability than the subject agent. Thus, the graph on the left shows the ratio of agents that ‘place the focus on each customer rank’ to agents having higher profitability than the subject agent”.

The reason for which it is determined in S605, S607, and S609 whether the number of extracted agents is greater than a predetermined threshold is that if the number of extracted agents is excessively small, the processing-target agents do not appropriately function as models. The threshold is determined as appropriate in accordance with the total number of agents, for example.

The second human resource development support process described above enables reference information having appropriate content, human resource development investment planning information having appropriate content, and training material content having appropriate content to be provided by taking into account the number of service personnel required, the number of managed machines, and so on.

### Other Embodiments

In the embodiment described above, processing-target agents are extracted without taking into account an area for which agents are responsible. Alternatively, processing-target agents may be extracted from among agents that are responsible for the same area as and areas adjacent to the area for which the subject agent is responsible.

In the embodiment described above, furthermore, when processing-target agents are to be extracted, agents having higher profitability indicator values than the subject agent are extracted. In addition, agents having the same profitability indicator value as that of the subject agent may also be extracted. Alternatively, agents having low profitability indicator values may be extracted. In this case, the processing-target agents function as negative models for the subject agent.

In the embodiment described above, furthermore, the grouping process is executed and any one of the first human resource development support process and the second human resource development support process is applied to each agent in accordance with the result of the grouping process. However, the present invention is not limited to this embodiment. The first human resource development support process and/or the second human resource development support process may be applied to all agents without using the grouping process.

In the embodiment described above, furthermore, all the processes of the computer program 14a are executed by a single computer 1a. However, the present invention is not limited to this configuration, and a distributed system may be used in which processes similar to those of the computer program 14a are executed by a plurality of apparatuses (computers) in a distributed manner.

A human resource development support system according to an embodiment of the present invention is suitable for use as a human resource development support system for supporting human resource development for service personnel involved in maintenance services for industrial machinery, for example.

1. A human resource development support system for supporting creating a plan for training and development of service personnel belonging to each of a plurality of agents of industrial machinery, the human resource development support system comprising:
a profitability indicator value calculation unit that calculates, for each of the plurality of agents, a profitability indicator value that is a value of an indicator of profitability of the agent on the basis of order histories for customers regarding industrial machinery at the agent;
a reference information generation unit that generates, for each of the plurality of agents, human-resource-development reference information capable of identifying a grade of service personnel for which human resource development is to be strengthened, on the basis of the profitability indicator value calculated by the profitability indicator value calculation unit and on the basis of constitution information indicating the numbers of service personnel belonging to the agent for individual grades; and
an output unit that outputs the human-resource-development reference information generated by the reference information generation unit.

2). The human resource development support system according to claim 1, wherein
the reference information generation unit is configured to generate human-resource-development reference information capable of identifying a grade of service personnel for which human resource development is to be strengthened in a first agent, on the basis of the constitution information on a second agent having a higher profitability indicator value than the first agent.

3. The human resource development support system according to claim 2, wherein
the reference information generation unit is configured to generate human-resource-development reference information capable of identifying a grade of service personnel for which human resource development is to be strengthened in a first agent, on the basis of the constitution information on a second agent having a service-providing-performance indicator value substantially equal to a service-providing-performance indicator value of the first agent and having a higher profitability indicator value than the first agent.

4. The human resource development support system according to claim 2, wherein
the reference information generation unit is configured to generate human-resource-development reference information capable of identifying a grade of service personnel for which human resource development is to be strengthened in a first agent, on the basis of the constitution information on a second agent having a number of service personnel substantially equal to the number of service personnel of the first agent and having a higher profitability indicator value than the first agent.

5. The human resource development support system according to claim 2, wherein
the reference information generation unit is configured to generate human-resource-development reference information capable of identifying a grade of service personnel for which human resource development is to be strengthened in a first agent, on the basis of the constitution information on a second agent having a larger number of service personnel than the first agent by a predetermined value and having a higher profitability indicator value than the first agent.

6. The human resource development support system according to claim 2, wherein the reference information generation unit is configured to generate human-resource-development reference information capable of identifying a grade of service personnel for which human resource development is to be strengthened in a first agent, on the basis of the constitution information on a second agent having a number of managed pieces of industrial machinery substantially equal to the number of managed pieces of industrial machinery of the first agent and having a higher profitability indicator value than the first agent.

7. The human resource development support system according claim 1, further comprising:
a customer ratio calculation unit that calculates, for each of the plurality of agents, customer ratios for individual ranks;
a customer ratio information generation unit that generates customer ratio information on customer ratios calculated for a second agent by the customer ratio calculation unit, the second agent being an agent having a higher profitability indicator value than a first agent; and
a second output unit that outputs the customer ratio information generated by the customer ratio information generation unit.

8. The human resource development support system according to claim 1, further comprising:
a storage unit that stores training material content corresponding to a grade of service personnel;
an extraction unit that extracts, from the storage unit, training material content corresponding to a grade of service personnel for which human resource development is to be strengthened, the grade being identifiable using the human-resource-development reference information; and
a providing unit that provides the training material content extracted by the extraction unit.

9. The human resource development support system according to claim 1, wherein
the profitability indicator value calculation unit includes
a rank setting unit that sets, for each of the plurality of agents, ranks of the customers on the basis of the order histories, and
a good-customer-proportion calculation unit that calculates, for each of the plurality of agents, a proportion of good customers on the basis of the ranks of the customers set by the rank setting unit, and
the profitability indicator value calculation unit is configured to calculate, for each of the plurality of agents, a profitability indicator value that is a value of an indicator of profitability of the agent on the basis of the proportion of good customers calculated by the good-customer-proportion calculation unit.

10. The human resource development support system according to claim 9, wherein
the reference information generation unit includes
a service-providing-performance indicator value calculation unit that calculates, for each of the plurality of agents, a service-providing-performance indicator value that is a value of an indicator of performance of the agent for providing services, on the basis of the numbers of service personnel belonging to the agent for the individual grades, and
a grouping unit that divides the plurality of agents into a plurality of groups on the basis of the calculated profitability indicator value and the service-providing-performance indicator value calculated by the service-providing-performance indicator value calculation unit, and
the reference information generation unit is configured to generate, for each of the plurality of groups obtained by the grouping unit, human-resource-development reference information capable of identifying a grade of service personnel for which human resource development is to be strengthened in each of the plurality of agents.

11. The human resource development support system according to claim 10, wherein
the profitability indicator value calculation unit and the service-providing-performance indicator value calculation unit are each configured to execute multiple regression analysis by using sales projection for a customer as a target variable and by using the numbers of service personnel for the individual grades and the calculated proportion of good customers as explanatory variables to acquire coefficients of the explanatory variables, and are configured to calculate a profitability indicator value and a service-providing-performance indicator value, respectively, on the basis of the acquired coefficients of the explanatory variables.
